(19) United States
(12) Patent Application Publication
(10) Pub. No.: US 2006/0062018 A1
(43) Pub. Date: Mar. 23, 2006

(54) Backlight unit

(75) Inventors: Myong Gi Jang, Seoul (KR); Hak Mo Hwang, Suwon-shi (KR)

Correspondence Address: BRINKS HOFER GILSON & LIONE, P.O. BOX 10395, CHICAGO, IL, 60610, US

(73) Assignee: LG PHILIPS LCD CO., LTD.

(21) Appl. No.: 11/157,284

(22) Filed: Jun. 21, 2005

(30) Foreign Application Priority Data
Sep. 17, 2004 (KR) P 2004-74571

(51) Int. Cl. F21V 7/04

(52) U.S. Cl. 362/613

(57) ABSTRACT

A backlight unit is disclosed, to obtain the simplified assembling process by simplifying the external structure, which includes a plurality of light-emitting lamps arranged in one direction; a cover bottom having a central bottom and a quadrangle frame formed as one body, to receive both ends of each of the light-emitting lamps; and a reflective sheet formed on the inner surface of the cover bottom.

This application claims the benefit of the Korean Application No. P2004-74571, filed on Sep. 17, 2004, which is hereby incorporated by reference.

### BACKGROUND OF THE INVENTION

1. Field of the Invention

The present invention relates to a backlight unit, and more particularly, to a backlight unit to obtain a simplified assembling process by simplifying the external structure.

2. Discussion of the Related Art

Demands for various display devices have increased with the ongoing development of an information society. Accordingly, many efforts have been made to research and develop various flat display devices such as liquid crystal display (LCD), plasma display panel (PDP), electroluminescent display (ELD), and vacuum fluorescent display (VFD). Some species of flat display devices have already been applied to displays for various equipment.

Among the various flat display devices, liquid crystal display (LCD) devices have been most widely used to provide a substitute for a Cathode Ray Tube (CRT) because of the advantageous characteristics such as a thin profile, low weight, and low power consumption. In addition, mobile type LCD devices, such as displays for notebook computers, have been developed for computer monitors and televisions to receive and display broadcasting signals.

Despite various technical developments in LCD technology that have applications in different fields, research in enhancing the picture quality of an LCD device has been, in some respects, lacking as compared to improvements in other features and advantages of the LCD device. In order to use LCD devices in various fields as a general display, LCD devices must be developed that can implement a high quality picture, such as high resolution and high luminance with a large-sized screen, while still being light weight, with a thin profile, and consuming relatively small amounts of power.

Generally, an LCD device includes lower and upper glass substrates and a liquid crystal layer that is formed between the lower and upper glass substrates. In this state, liquid crystal molecules of the liquid crystal layer are aligned to represent the picture image based on the voltage difference between electrodes formed on the lower and upper glass substrates.

The LCD device does not itself emit light. Instead, the LCD device displays an image by controlling light transmittance from an external light source. Therefore, an LCD device requires an additional light source, such as a backlight. The backlight is classified as either a direct type or an edge type backlight depending on the arrangement of the plurality of cylindrical light-emitting lamps.

In an edge type backlight, a lamp unit is provided at a lateral side of a light-guiding plate. The lamp unit includes a light-emitting lamp, a lamp holder inserted into both ends of the light-emitting lamp to protect the light-emitting lamp, and a reflective sheet that reflects light emitted from the light-emitting lamp to the light-guiding plate. The edge type backlight unit is generally used in relatively small sized LCD devices such as monitors of laptop computers and desktop computer, since the edge type backlight is advantageous to light uniformity, long lifespan, and a thin profile.

With trend toward larger LCD devices of 20 inches or more, the direct type backlight is being actively developed. In a direct type back light, a plurality of lamps are formed in parallel on a lower surface of a light-diffusion sheet, whereby the entire surface of the LCD panel is directly illuminated with the light. The direct type method is used for the large-sized LCD device requiring high luminance because it has the great light efficiency. Therefore, the direct type backlight is generally used for large-sized monitors or televisions. Because large sized monitors or televisions normally operate for a long service life, it is not uncommon to have individual lamps within the direct type backlight fail. In the direct type LCD device, a plurality of lamps are formed underneath a screen. Accordingly, if one of the lamps fails due to malfunctions of the lamp or the end of the lamp's life, the portion of the LCD screen corresponding to the failed lamp portion becomes darker than the surrounding portions of the screen. Therefore, the direct type LCD device must have a simple structure that is suitable for disassembly and assembly of the lamp unit to allow for easy and quick lamp replacement.

Hereinafter, a liquid crystal display module (LCM) having a backlight unit according to the related art will be described with reference to the accompanying drawings.

FIG. 1 is a perspective view of an LCM having a backlight unit according to the related art. As shown in FIG. 1, a related art LCM includes an LCD panel 10, a backlight unit 20, and a case top 30. The LCD panel 10 is provided in the front of the LCD module, to display the picture image. The backlight unit 20 is provided in the rear of the LCD panel 10, wherein the backlight unit 20 serves as a light source of the LCD panel 10. The case top 30 of a quadrangle frame covers the front and side of the LCD panel 10.

The LCD panel 10 is comprised of two glass substrates with a liquid crystal layer between the two glass substrates. Each of the two glass substrates has a polarizing sheet, and the two glass substrates are bonded to each other. Also, the liquid crystal layer is formed between the two glass substrates, and liquid crystal molecules of the liquid crystal layer are selectively aligned to transmit and block the light, thereby displaying the picture image.

The backlight unit 20 includes a cover bottom 21, a plurality of light-emitting lamps 22, a plurality of lamp holders 23, and first and second side supporters 24a and 24b. The plurality of light-emitting lamps 22 are formed in one direction above the cover bottom 21. The plurality of lamp holders 23 are provided to the both ends of the light-emitting lamps 22, in order to support and fix the light-emitting lamps 22. The first and second side supports 24a and 24b are provided to cover the lamp holders 23 and both ends of the light-emitting lamps 22. In this case, the first and second side supports 24a and 24b are provided for protection and assembly of the electrodes formed at both ends of the light-emitting lamps 22.

In addition, the backlight unit 20 includes a plurality of supporters 25 and a reflective sheet 26. The plurality of supporters 25 are provided inside the cover bottom 21, to fix the light-emitting lamps 22 within the backlight unit 20. The reflective sheet 26 is provided on the inner surface of the cover bottom 21.

Although not shown, a light-scattering means is provided that includes a plurality of diffusion sheets and diffusion plates located between the light-emitting lamps 22 and the LCD panel 10. The light-scattering means prevents the silhouette of the light-emitting lamps from being seen on the LCD surface of the display panel (10) and provides light source with a uniform luminance.

The related art backlight unit has the following disadvantages. For example, the related art backlight unit 20 requires first and second side supporters 24a and 24b as well as a cover bottom 21 for protection and assembly of the electrodes formed at both ends of the light-emitting lamps 22. Accordingly, it requires the complicated assembling process, which lowers manufacturing efficiency and therefore the manufacturing yield.

### SUMMARY OF THE INVENTION

A backlight unit is provided with a simplified external structure to obtain a simplified assembling process.

A backlight unit includes a plurality of light-emitting lamps arranged in one direction, a cover bottom having a central bottom and a quadrangle frame formed as one body to receive both ends of each of the light-emitting lamps, and a reflective sheet formed on the inner surface of the cover bottom.

Additional advantages, objects, and features of the invention are set forth in part in the description that follows and in part will become apparent to those having ordinary skill in the art upon examination of the following or may be learned from practice of the invention. The objectives and other advantages of the invention may be realized and attained by the structure particularly pointed out in the written description and claims herein as well as the appended drawings.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanied drawings, which are included to provide a further understanding of the invention and are incorporated in and constitute a part of this application, illustrate various embodiment(s) of the invention and together with the description serve to explain the principle of the invention. In the drawings:

FIG. 1 is a perspective exploded view of an LCM having a backlight unit according to the related art;

FIG. 2A is a perspective view of a backlight unit according to the first embodiment of the present invention;

FIG. 2B is a cross-sectional view along I-I′ of FIG. 2A;

FIG. 3A is a perspective view of a backlight unit according to the second embodiment of the present invention;

FIG. 3B is a cross-sectional view along II-II′ of FIG. 3A; and

FIG. 4 is a perspective view of a backlight unit according to the third embodiment of the present invention.

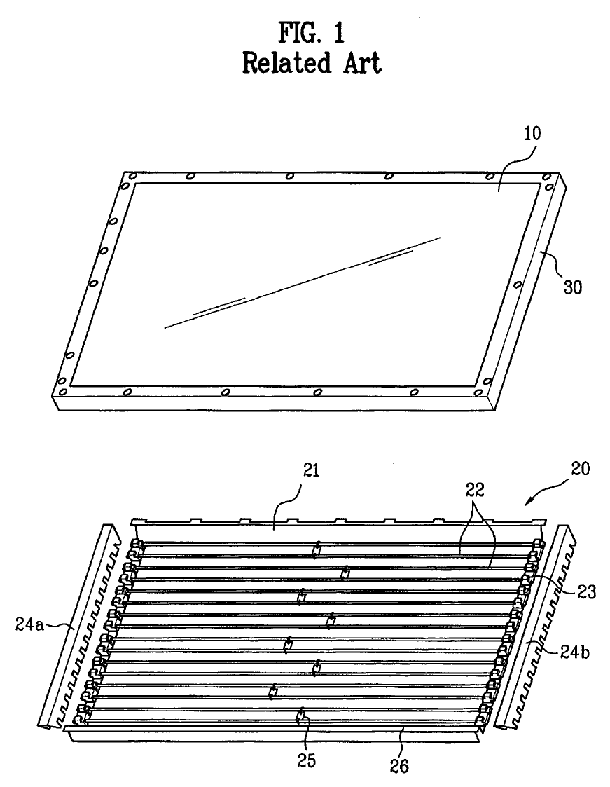

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Hereinafter, a backlight unit according to the present invention will be described with reference to the accompanying drawings.

### First Embodiment

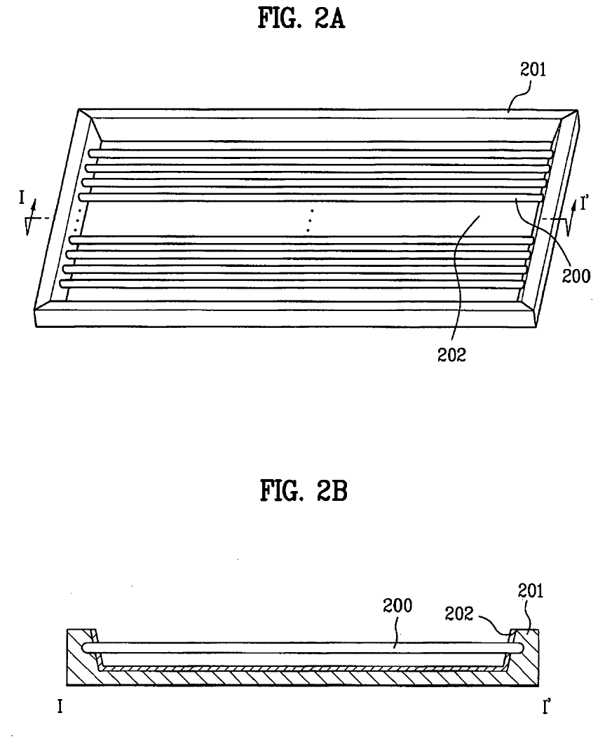

FIG. 2A is a perspective view of a backlight unit according to the first embodiment of the present invention. FIG. 2B is a cross-sectional view along I-I′ of FIG. 2A.

As shown in FIG. 2A and FIG. 2B, a backlight unit according to the first embodiment of the present invention includes a plurality of light-emitting lamps 200, a cover bottom 201, and a reflective sheet 202. As shown in FIG. 2A, the plurality of light-emitting lamps 200 are arranged in one direction on the cover bottom 201. The cover bottom 201 is comprised of a quadrangle frame having four relatively high edges, and a relatively low central bottom. Also, the cover bottom 201 has a plurality of holes on both inner side surfaces of the four edges thereof. When assembled, both ends of each of the light-emitting lamps 200 are inserted into the holes formed in the quadrangle frame of the cover bottom 201. The reflective sheet 202 is formed on the inner bottom surface of the cover bottom 201.

Each of light-emitting lamps 200 are formed as straight lines. The light-emitting lamps 200 may be formed from a cold cathode light-emitting lamp (CCFL) in which electrodes are positioned at both inner ends of a tube. Also, the light-emitting lamp 200 may be formed of an external electrode light-emitting lamp (EEFL), or an external internal light-emitting lamp (EIFL), wherein the EEFL has a positive (+) electrode and a negative (−) electrode at respective both external ends thereof.

The reflective sheet 202 is provided on the inner surface of the cover bottom 201, whereby the light emitted from the light-emitting lamp 200 is concentrated to the LCD panel (not shown) in order to maximize the light efficiency.

Although not shown, a light-scattering means including a plurality of diffusion sheets and diffusion plates are provided between the light-emitting lamps 200 and the LCD panel (not shown). The light-scattering means prevents the silhouette of the light-emitting lamps from being seen on the display surface of the LCD panel (not shown), and provides a light source with uniform luminance.

Although not shown, there are electrode plates provided on both ends of the light-emitting lamps 200, that apply a voltage to the light-emitting lamps 200.

In the backlight unit according to the first embodiment of the present invention, the cover bottom 201 is comprised of the central bottom and the quadrangle frame formed as one body. As a result of this structure, there is no requirement of additional first and second side supporters for protection of the electrodes and assembly of the backlight unit.

Accordingly, the backlight unit according to the first embodiment of the present invention does not require the manufacturing step of inserting fasteners to the first and second side supporters. Therefore, it is possible to obtain the simplified assembling process thereby decreasing production cost and increasing manufacturing efficiency.

### Second Embodiment

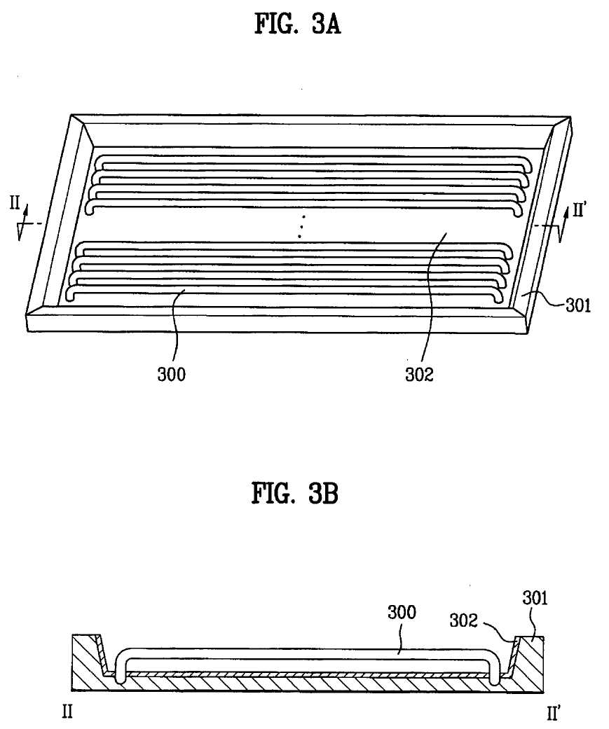

FIG. 3A is a perspective view of a backlight unit according to a second embodiment of the present invention. FIG. 3B is a cross sectional view along II-II′ of FIG. 3A.

As shown in FIG. 3A and FIG. 3B, a backlight unit according to a second embodiment of the present invention includes a plurality of light-emitting lamps 300, a cover bottom 301, and a reflective sheet 302. In this embodiment, as shown in FIG. 3B, the two ends of each light-emitting lamp 300 has a bent shape. Also, the cover bottom 301 is comprised of a central bottom and a quadrangle frame formed as one body, wherein the quadrangle frame is relatively higher than the central bottom, and the central bottom has a plurality of holes to receive the ends of the light-emitting lamps 300.

As discussed above, each of the light-emitting lamps 300 have two ends that are bent in an approximate ninety degree angle with respect to the central section of the light-emitting lamps 300. The light-emitting lamp 300 may be formed of a cold cathode light-emitting lamp (CCFL) in which electrodes are positioned at both inner ends of a tube. Also, the light-emitting lamp 300 may be formed of an external electrode light-emitting lamp (EEFL), or an external internal light-emitting lamp (EIFL), wherein the EEFL has a positive (+) electrode and a negative (−) electrode at respective both external ends thereof.

In embodiments where both ends of the light-emitting lamp 300 are bent, it is advantageous in that the backlight unit is driven with a low voltage source by decreasing the length of the electrodes at each end of the tube.

The reflective sheet 302 is formed on the inner surface of the cover bottom 301, whereby the light emitted from the light-emitting lamp 300 is concentrated on the LCD panel (not shown), in order to maximize the light efficiency.

Although not shown, the embodiment includes a light-scattering means including a plurality of diffusion sheets and diffusion plates provided between the light-emitting lamps 300 and the LCD panel. The light-scattering means prevents the silhouette of the light-emitting lamps from being seen on the display surface of the LCD panel (not shown) and provides a light source with uniform luminance.

Although not shown, electrode plates are provided on both ends of the light-emitting lamps 300, to apply a voltage to the light-emitting lamps 300. In the backlight unit according to the second embodiment of the present invention, the cover bottom 301 is comprised of the central bottom and the quadrangle frame as one body. As a result, there is no requirement of additional first and second side supporters for protection of the electrodes and assembly of the backlight unit.

### Third Embodiment

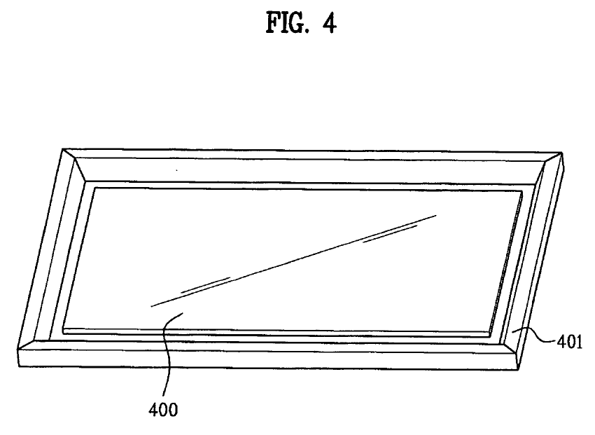

FIG. 4 is a perspective view of a backlight unit according to the third embodiment of the present invention.

As shown in FIG. 4, a backlight unit according to the third embodiment of the present invention includes a flat type lamp 400 and a cover bottom 401. The cover bottom 401 is comprised of a central bottom and a quadrangle frame formed as one body. In this state, the flat type lamp 400 is received in the central bottom of the cover bottom 401 through the quadrangle frame.

Although not shown, the flat type lamp 400 is comprised of lower and upper substrates being bonded to each other at a predetermined interval therebetween, supporters for maintaining the predetermined interval between the lower and upper substrates, anode and cathode electrodes alternately provided on the lower substrate, and mixed gas of Ne, Hg and Xe provided between the lower and upper substrates bonded to each other. In another aspect, the flat type lamp 400 may be comprised of only lower and upper substrates being bonded to each other in state of providing a light-emitting gas therebetween.

In the backlight unit according to the third embodiment of the present invention, it is possible to decrease the production cost and to improve the uniformity of luminance with the flat type lamp.

The flat type lamp 400 is fixed to the central bottom of the cover bottom 401 through the quadrangle frame of the cover bottom 401. That is, the four edges of the cover bottom 401 are higher than the central bottom surface, which are formed in shape of the quadrangle frame.

Accordingly, it is possible to simplify the external structure of the backlight unit with the cover bottom 401.

Accordingly, the backlight unit according to the third embodiment of the present invention does not require additional first and second side supporters. As a result, there is no requirement to use screws when assembling the first and second side supporters, which provides a simplified assembling process, and decreases the production cost and manufacturing efficiency of the unit.

As mentioned above, the backlight unit according to the present invention has the following advantages. First, the light-emitting lamp or the flat type lamp is fixed to the cover bottom without using the additional screws or other fasteners, which results in a more simplified external structure of the backlight unit. Second, the backlight unit according to the present invention does not require the additional first and second side supporters, thereby decreasing the production cost because of a simplified assembling process.

It will be apparent to those skilled in the art that various modifications and variations can be made in the present invention. Therefore, it is intended that the present invention covers the modifications and variations of this invention provided they come within the scope of the appended claims and their equivalents.

What is claimed is:

1. A backlight unit comprising:
a plurality of light-emitting lamps arranged in one direction, the lamps each having two ends;
a cover bottom comprising a central bottom and a quadrangle frame as one body to receive both ends of each of the light-emitting lamps;
a reflective sheet formed on the inner surface of the cover bottom.

2. The backlight unit of claim 1, wherein the quadrangle frame further comprises two sets of parallel inner side surfaces, with one set of parallel inner side surfaces including a plurality of holes for receiving the ends of each of the light-emitting lamps.

3. The backlight unit of claim 1, wherein the quadrangle frame is formed of four edges, the four edges being higher than the central bottom.

4. The backlight unit of claim 1, wherein the light-emitting lamp is shaped as a straight line.

5. The backlight unit of claim 1, wherein the light-emitting lamp is formed of a lamp selected from the group consisting of a cold cathode light-emitting lamp (CCFL), an external electrode light-emitting lamp (EEFL), and an external internal light-emitting lamp (EIFL).

6. A backlight unit comprising:
a plurality of light-emitting lamps, each having two ends in a bent structure;
a cover bottom having a central bottom and a quadrangle frame formed as one body, the cover bottom capable of receiving the bent ends of each of the light-emitting lamps; and
a reflective sheet formed on an inner surface of the cover bottom.

7. The backlight unit of claim 6, wherein the cover bottom has a plurality of holes along both sides of the central bottom, capable of receiving the bent ends of each of the light-emitting lamps.

8. The backlight unit of claim 6, wherein the quadrangle frame is formed of four edges, with the four edges being relatively higher than the central bottom.

9. The backlight unit of claim 6, wherein the light-emitting lamp having the bent both ends is formed of a lamp selected from the group consisting of a cold cathode light-emitting lamp (CCFL), an external electrode light-emitting lamp (EEFL), and an external internal light-emitting lamp (EIFL).

10. A backlight unit comprising:
a flat type lamp; and
a cover bottom having a central bottom and a quadrangle frame formed as one body, to receive the flat type lamp therein.

11. The backlight unit of claim 10, wherein the quadrangle frame is formed of four edges, the four edges being higher than the central bottom.

12. A liquid crystal display device comprising:
a liquid crystal display panel; and
a backlight unit, wherein the backlight unit includes;
a plurality of light-emitting lamps arranged in one direction, with the lamps each having two ends;
a cover bottom having a central bottom and a quadrangle frame formed as one body, the cover bottom receiving both ends of each of the light-emitting lamps; and
a reflective sheet formed on an inner surface of the cover bottom.

13. The liquid crystal display device of claim 12, wherein the quadrangle frame has two sets of parallel inner side surfaces with a plurality of holes on one of the sets of surfaces, the holes adapted for receiving both ends of each of the light-emitting lamps.

14. The liquid crystal display device comprising:
a liquid crystal display panel; and
a backlight unit, wherein the backlight unit comprises:
a plurality of light-emitting lamps, each having two ends in a bent structure;
a cover bottom having a central bottom and a quadrangle frame formed as one body, the cover bottom receiving the bent ends of each of the light-emitting lamps; and
a reflective sheet formed on an inner surface of the cover bottom.

15. The liquid crystal display device of claim 14, wherein the cover bottom has a plurality of holes along both sides of the central bottom, with the holes being adapted for receiving the bent ends of each of the light-emitting lamps.

16. The liquid crystal display device comprising:
a liquid crystal display panel; and
a backlight unit, wherein the backlight unit comprises
a flat type lamp; and
a cover bottom having a central bottom and a quadrangle frame formed as one body, wherein the cover bottom receives the flat type lamp therein.

17. The backlight unit of claim 16, wherein the quadrangle frame is formed of four edges, the four edges being relatively higher than the central bottom.
